(19) United States
(12) Patent Application Publication
(10) Pub. No.: US 2002/0140848 A1
(43) Pub. Date: Oct. 3, 2002

(54) Controllable sealed chamber for surveillance camera

(75) Inventors: Cliff Lawrence Cooper, Clovis, CA (US); Joshua Ryan Cockrum, Fresno, CA (US); Michael Timothy Higgins, Fresno, CA (US); Shane E. Compton, Fresno, CA (US)

Correspondence Address: MARK D MILLER, KIMBLE, MACMICHAEL & UPTON, 5260 NORTH PALM AVENUE, SUITE 221, FRESNO, CA, 93704, US

(73) Assignee: Pelco

(21) Appl. No.: 10/106,784

(22) Filed: Mar. 25, 2002

Related U.S. Application Data
(63) Continuation-in-part of application No. 29/139,520, filed on Mar. 30, 2001.
(60) Provisional application No. 60/280,715, filed on Mar. 30, 2001.

(51) Int. Cl. H04N 5/225

(52) U.S. Cl. 348/373

(57) ABSTRACT

A chamber for a surveillance camera that is designed to be mounted inside a larger camera housing. The chamber is sealed and provides a controlled internal environment for sensitive camera optics and internal electronics. A flush mount window is provided for the front lens of the camera, and a sealed feed-through electronic connector is provided for attachment to external controls. Valves for both adding and removing gasses to/from the chamber are provided. In one embodiment, temperature, pressure and/or humidity sensors may be deployed inside the chamber and connected electronically to a display or computer for monitoring and adjustment. In another embodiment of, a heating element is provided to evaporate moisture from the camera lens and/or from the window, and to help control the temperature inside the chamber.

This application claims the benefit of U.S. provisional application No. 60/280,715 filed on Mar. 30, 2001, and of U.S. design patent application No. 29/139,520 filed on Mar. 30, 2001.

### BACKGROUND OF THE INVENTION

1. Field of the Invention.

The present invention relates to surveillance camera systems, and more particularly to a mounting apparatus including a controllable sealed chamber or enclosure for a surveillance camera (pressurized ESPRIT) designed to be mounted inside a larger camera housing in order to provide the camera and its associated electronics with a controlled and monitored atmosphere.

2. Description of the Prior Art

The use of surveillance cameras and related systems is becoming increasingly more prevalent. Not only are surveillance cameras used in such traditional institutions as banks and casinos, but their use has spread to retail and business establishments, indoor and outdoor entry points, airport security checkpoints, government buildings, and the like.

In the field of surveillance cameras, it is often desirable for a surveillance camera to be mounted in a housing that is located in a remote or outdoor location (such as the top of a pole, the underside of an eave, etc.) where it is exposed to wide variations in temperature, pressure and humidity. Many existing outdoor camera housing enclosures include fans and/or heaters to help control the interior environment, but they are not sealed. As a result, such enclosures have limited ability to adapt to changing climactic conditions. More importantly, they are unable to compensate for changes in pressure and humidity that can be particularly harmful to the delicate internal electronics and camera optics of surveillance camera systems, and that may impair, damage or shorten the life of these components.

Some existing camera housings are sealed in order to prevent moisture and debris from entering the enclosure. However, these simple sealed enclosures do not compensate for changes in pressure so that, over time, changes in air pressure may result in the rupture of the housing seal(s) exposing the internal electronics and camera to the damaging effects of the external environment. The device disclosed in U.S. Pat. No. 5,852,754 includes a large sealed chamber having a gas input valve for maintaining internal pressure. However, this device only solves part of the problem since it does not maintain a humidity-free internal environment, nor does is allow for pressure to be reduced or removed (i.e., an internal vacuum). In addition, such a large chamber has numerous potential failure points where pressure leaks can occur. As a result, even without any break in the seal, some level of moisture or humidity will inevitably be trapped inside the sealed housing, and is subject to movement throughout the housing resulting from heating (evaporation) and cooling (condensation) of the housing by the external climate. This movement may cause moisture to be deposited in sensitive areas where it can lead to corrosion and shorten the life of the sensitive electronic components. In addition, such trapped moisture may also condense on the inside of the housing window, or may condense on the camera lenses themselves, thereby obscuring the view of the camera.

It is therefore desirable to provide a controllable internal environment for protecting the lenses, sensitive electronics, and other delicate parts of a surveillance camera mounted inside a housing that is deployed in a harsh external environment by providing a sealed chamber that is capable of compensating for changes in temperature, pressure and humidity.

### SUMMARY OF THE INVENTION

The present invention provides a controlled internal environment for the sensitive internal electronics and camera optics of a surveillance camera system through a small sealed chamber that is mounted inside a larger camera housing. The small chamber is made of two sections, connected together using a sealing gasket made of a suitable flexible waterproof and airtight material. The front section of the chamber has a flush mount window for the front lens of the camera, and the rear section has a sealed feed-through electronic connector, as well as valves for both adding and removing gasses to/from the chamber.

Because of its small size and simple construction, the sealed chamber of the present invention may be easily deployed in any of a wide range of larger (unsealed) housing structures. The small chamber also has few potential failure points, minimizing the chances of pressure leaks, and allowing for maintenance of higher internal pressures over longer periods of time, if desired. The chamber includes both input and output valves that are attached, respectively, to pressure-imparting and suction apparatus. The output valve allows for the removal of some or all gasses from the inside of the chamber, establishing a vacuum if desired. The output valve is useful for the removal of dust, debris, moisture, and other impurities from inside the chamber. The removal of water vapor is particularly important since it eliminates the potential for condensation on the camera lenses, which could impair viewing, or on sensitive electronics or circuitry which could cause corrosion or failure.

The input valve allows for clean and/or inert gasses (such as nitrogen) to be introduced into the chamber, and for high internal pressures to be achieved. The combination of input and output valves allows the pressure inside the chamber to be increased, decreased or otherwise varied as desired, and to be controlled at all times.

In one aspect of the invention, temperature, pressure and/or humidity sensors may be deployed inside the chamber and connected electronically to a display or computer for monitoring and adjustment.

In another aspect of the invention, a heating element is provided for deployment in the near vicinity of the front lens of the camera and is used to evaporate moisture from the camera lens and/or from the window in the front section of the chamber. The heating element may also be used to control the temperature inside the chamber.

It is therefore a primary object of the present invention to provide a small sealed chamber for holding a surveillance camera and its associated electronics to protect the camera and electronics from potential damage from harsh external environmental conditions.

It is also a primary object of the present invention to provide a small sealed chamber for holding a surveillance camera and its associated electronics that has input and output gas valves allowing for the introduction of gasses to and/or the removal of gasses and other materials from the inside of the chamber.

It is also a primary object of the present invention to provide a small sealed chamber for holding a surveillance camera and its associated electronics that has input and output gas valves that allow for continuous control and adjustment of the internal pressure of the chamber.

It is another important object of the present invention to provide a small sealed chamber for holding a surveillance camera and its associated electronics having sensors for detecting the temperature, pressure and/or humidity inside the chamber so that these conditions may be monitored and controlled from the outside.

It is a further object of the present invention to provide a small sealed chamber for holding a surveillance camera and its associated electronics having a heating element deployed in the near vicinity of the camera lenses and the transparent window in the chamber to evaporate moisture from these surfaces and to control the internal temperature of the chamber.

Additional objects of the invention will be apparent from the detailed descriptions and the claims herein.

### BRIEF DESCRIPTION OF THE DRAWINGS

FIG. 1 is a front perspective view of the chamber of the present invention.

FIG. 2 is a rear perspective view of the chamber of the present invention.

FIG. 3 is a partially exploded front perspective view of the chamber of the present invention.

FIG. 4 is a partially exploded rear perspective view of the chamber of the present invention.

FIG. 5 is a perspective view of a camera housing in which the chamber of the present invention has been deployed.

FIG. 6 is a perspective view of a camera housing in which the chamber of the present invention has been deployed with the housing cover removed.

FIG. 7 is another perspective view of a camera housing in which the chamber of the present invention has been deployed with the housing cover removed.

FIG. 8 is a perspective view of a camera housing showing the chamber of the present invention, with the housing cover removed.

FIG. 9 is a diagrammatic exploded side view of the present invention and camera.

FIG. 10 is a diagrammatic cut away view of the present invention mounted in an existing pan and tilt or fixed mount system for a closed circuit television camera.

### DETAILED DESCRIPTION OF A PREFERRED EMBODIMENT

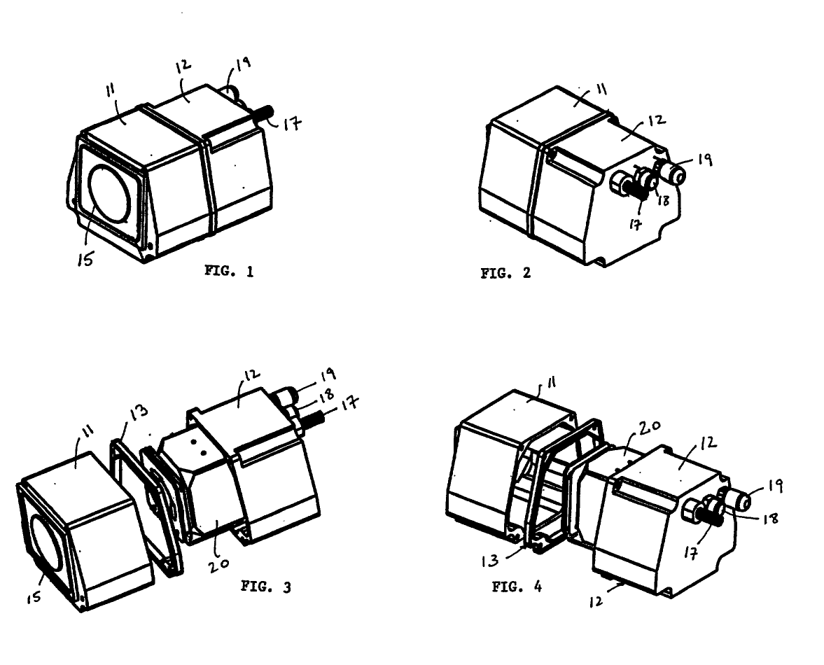

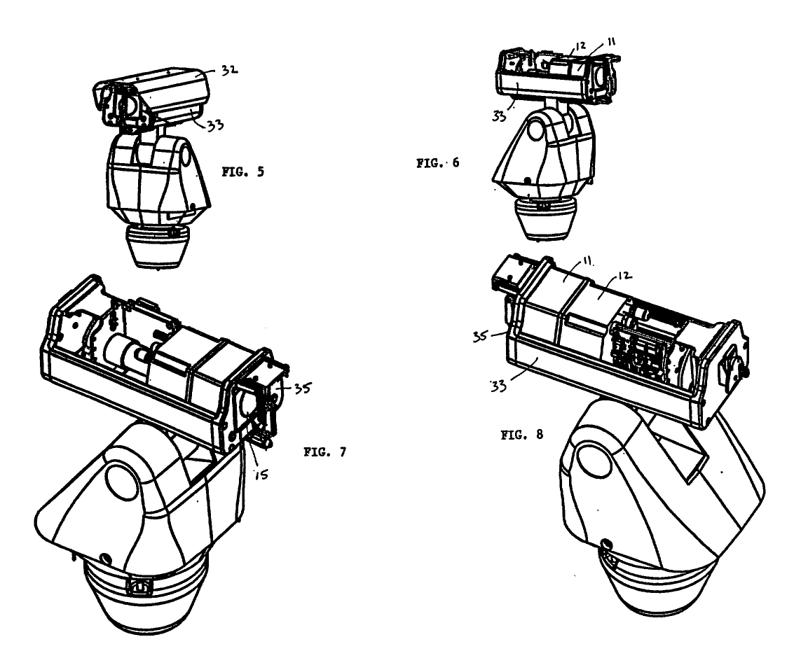

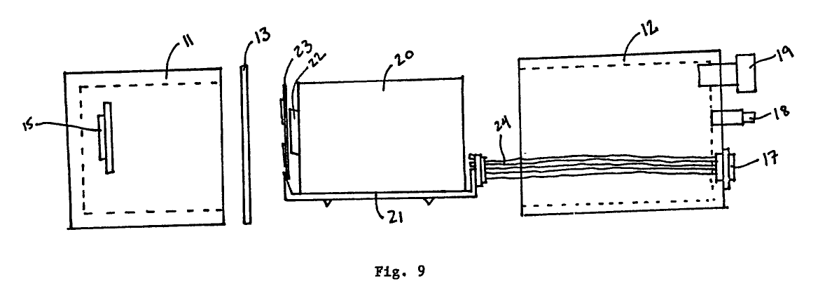

Referring to the drawings wherein like reference characters designate like or corresponding parts throughout the several views, and referring particularly to FIGS. 1-4, it is seen that the chamber of the present invention includes a front housing or outer shell 11, a rear housing or outer shell 12, and a gasket 13 for sealingly connecting shell 11 to shell 12 to form a sealed chamber 11-12. Front shell 11 is provided with a transparent window 15 for flush mounting with the front 35 of external housing 33 (see FIG. 7). Rear shell 12 is provided with a sealed feed through connector 17 so that pressure may be maintained inside chamber 11-12 while electronic signals may be sent to and from camera 20 inside. Rear shell 12 is also provided with an input valve 19 and an output valve 18. Input valve 19 is provided to allow chamber 11-12 to be filled with an appropriate gas, preferably inert, and preferably moisture-free. Purge valve 18 is provided to allow gas, dust and moisture to be removed from chamber 11-12, and may also be used to create a vacuum inside chamber 11-12.

Camera 20 is mounted on a bracket 21 inside chamber 11-12. Bracket 21, camera 20, optional heater 23 and wiring 24 are all inserted into chamber 11-12 which is sealed together, with wiring 24 attached to connector 17. Chamber 11-12 is then installed into external housing 33, with window 15 flush mounted to the front 35 of housing 33. Housing 33 may then itself be sealed using cover 32.

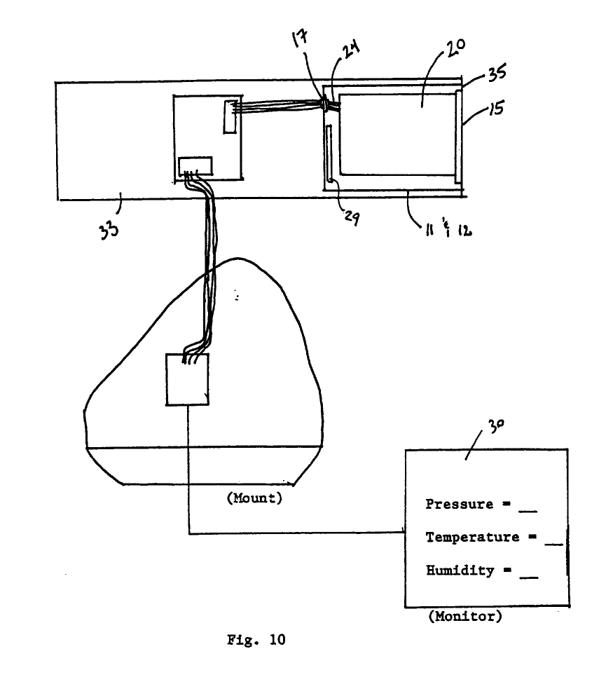

Wiring 24 is used to send control signals to the camera 20 and optional heater 23, and also to receive output from the camera and optional sensors 29 inside chamber 11-12 that monitor the pressure, temperature and humidity. This information may be displayed to the user on an appropriate monitor 30 as shown in FIG. 10, allowing for detection and correction of improper conditions. The information may also be provided to a computer or other controlling mechanism so that the internal environment may be changed by adjusting the gas input and output and the optional heater 23.

In one embodiment, bracket 21 supports an optional heating element 23 that is placed in close proximity to the front lens 22 of camera 20. Heater 23 is controlled from the outside and is used to evaporate moisture from camera lens 20 and window 15 and to control the temperature inside the chamber.

In another embodiment, sensors 29 for temperature, pressure and humidity are deployed inside chamber 11-12 to report these conditions for display on a monitor 30, or as input to a control mechanism for use in monitoring and adjusting temperature and pressure using the heater 23 and the input and output valves 18 & 19.

In another embodiment, a single valve may be provided instead of dual valves 18 and 19, the single valve providing for both input and output of gasses from the sealed chamber.

It is to be appreciated that the size, shape and configuration of shells 11 and 12, as well as the position, deployment and locations of bracket 21, camera 20, heater 23, connector 17, and valves 18 and 19 may all be changed or adjusted depending on the conditions and camera used; and that such features may be used in any combination with each other, or some features eliminated, without departing from the scope hereof.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A sealed enclosure for a surveillance camera comprising a first open-ended housing, a second open-ended housing corresponding to said first housing, and a gasket member for sealing engagement between the open ends of said housings, said housings and gasket forming a sealed chamber having an outer wall, said wall having a transparent window, a gas input valve, a gas output valve, and an electronic connector located therein.

2. The enclosure of claim 1 wherein said chamber is designed for deployment inside a surveillance camera support housing.

3. The enclosure of claim 2 wherein at least one sensor is provided inside said chamber for sensing a condition selected from the group consisting of temperature, pressure and humidity, and wherein said at least one sensor is in communication with an external display.

4. The enclosure of claim 3 wherein said at least one sensor is in communication with an external control that is capable of controlling the introduction and removal of gas from said chamber through said valves.

5. The enclosure of claim 4 wherein a heating element is provided inside said chamber, said heating element being in communication with said external control.

6. The enclosure of claim 5 wherein said heating element control is capable of causing the temperature inside said chamber to be changed by selective activation of said heating element.

7. A sealed enclosure for a surveillance camera comprising a pair of open-ended shells and a gasket member for sealing attachment between said shells to form a sealed chamber having an outer wall, a transparent window in said chamber wall for alignment with lenses of said camera, a first valve in said chamber wall for introduction of gas into said chamber, a second valve in said chamber wall for removal of gas from said chamber, and an electronic connector in said chamber wall for electronic communication between the inside and outside of the chamber.

8. The enclosure of claim 7 wherein said chamber is designed for deployment inside a surveillance camera support housing.

9. The enclosure of claim 8 wherein at least one sensor is provided inside said chamber for sensing a condition selected from the group consisting of temperature, pressure and humidity, and wherein said at least one sensor is in communication with an external display.

10. The enclosure of claim 9 wherein said at least one sensor is in communication with an external control that is capable of controlling the introduction and removal of gas from said chamber through said valves.

11. The enclosure of claim 10 wherein a heating element is provided inside said chamber, said heating element being in communication with said external control.

12. The enclosure of claim 11 wherein said heating element control is capable of causing the temperature inside said chamber to be changed by selective activation of said heating element.

13. A surveillance camera support apparatus comprising a sealed chamber for enclosing said camera, said chamber including a first shell and a corresponding second shell separated by a gasket member for sealing attachment between said shells, a transparent window in one of said shells for alignment with lenses of said camera, a first valve in one of said shells for introduction of gas into said chamber, a second valve in one of said shells for removal of gas from said chamber, and an electronic connector in one of said shells for electronic communication between the inside and outside of the chamber, said chamber being designed for deployment inside a camera support housing.

14. The support apparatus of claim 13 wherein at least one sensor is provided inside said chamber for sensing a condition selected from the group consisting of temperature, pressure and humidity, and wherein said at least one sensor is in communication with an external display.

15. The support apparatus of claim 14 wherein said at least one sensor is in communication with an external control that is capable of controlling the introduction and removal of gas from said chamber through said valves.

16. The support apparatus of claim 15 wherein a heating element is provided inside said chamber, said heating element being in communication with said external control.

17. The support apparatus of claim 16 wherein said heating element control is capable of causing the temperature inside said chamber to be changed by selective activation of said heating element.
